(19) United States
(12) Patent Application Publication
(10) Pub. No.: US 2008/0017291 A1
(43) Pub. Date: Jan. 24, 2008

(54) Structured inorganic materials and method for making and using same

(75) Inventors: Yongsoon Shin, Richland, WA (US); James F. White, Richland, WA (US); Gregory J. Exarhos, Richland, WA (US); Yong Wang, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/488,351

(22) Filed: Jul. 18, 2006

(51) Int. Cl. B31B 1/60

(52) U.S. Cl. 156/1

(57) ABSTRACT

The invention relates generally to hierarchical inorganic materials and a method for making and using same. The materials of the invention have a controlled hardness, porosity, and surface area ideally suited for use as, e.g., durable catalyst supports for reactions conducted in severe and/or hydrothermal environments. The materials of the invention are prepared by infusing hierarchical templates of suitably shaped sized cellulosic or lignocellulosic particles (e.g., from wood, bamboo, and the like) with soluble transition-metal and/or ceramic precursors. Infused templates are heated in a gaseous atmosphere until volatile chemical components are removed. After drying, the infused templates are heated under flowing argon, helium, or air atmosphere for several hours to remove volatiles and convert all or part of the transition-metal and/or ceramic precursors to respective carbide, oxycarbide, or other chemical forms.

This invention was made with Government support under Contract DE-AC0676RLO-1830 awarded by the U.S. Department of Energy. The Government has certain rights in the invention.

### FIELD OF THE INVENTION

The present invention relates generally to structured inorganic materials and a method for making and uses for same. The invention finds application in such areas as catalysts, catalyst supports and adsorbent materials.

### BACKGROUND OF THE INVENTION

Transition-metal carbides and nitrides are key materials due to their hardness and chemical stability at high temperatures and find application as abrasives and in such industries as manufacture of cutting tools. Several methods for preparing transition-metal (e.g., Ti) carbide powders have been reported in the literature, including (1) direct carbonization of the metal, (2) pyrolysis of the metal halide in an alkane-containing gas stream, and (3) carbothermal reduction of the metal oxide (e.g., TiO₂) with carbon at high temperature. Direct carbonization and pyrolysis of metal halides require relatively expensive starting materials and frequently produce materials that are contaminated by high oxygen content. Carbothermal reduction typically requires metal precursors that are easily hydrolyzed by moisture, even in air, making processing difficult.

Use of natural biological materials as templates to construct inorganic materials is an emerging area of interest due to the unique and complex microstructures of these materials. Compared to artificial templates, biological materials are hierarchical, abundant, complex, renewable, and environmentally benign. However, drawbacks to use of templates are well known in the art and include high expense, low surface area, low porosity, and difficulty in making suitably formed shapes in a controllable manner.

Accordingly, new methods are needed for preparation of transition metal carbides.

### SUMMARY OF THE INVENTION

In one aspect, the invention is a method for preparing structured inorganic materials (e.g., metal carbides, metal nitrides), comprising the steps: providing a hierarchical template comprising a cellulosic, lignocellulosic, or porous carbon material and a carbonaceous precursor; introducing a ceramic (e.g., Si) and/or metal precursor (e.g., TiO₂, ZrO₂, Nb₂O₅, WO₃, or the like) in a solvent into the matrix of the hierarchical template substantially infusing the template, the ceramic and/or metal precursor cross-linking within the matrix of the template; heating the infused template in an gaseous atmosphere (e.g., in Ar He, N₂, NH₃, H₂, etc.) at a temperature and duration whereby the ceramic and/or metal precursor is converted to an inorganic product with free carbonaceous structures, including, but no limited to, a stable oxide, a metal carbide, a metal oxycarbide, a metal nitride; optionally removing the free carbonaceous structures; and wherein a final product is produced having a controlled hardness, porosity, shape, and/or surface area.

In an embodiment, the hierarchical template is composed of cellulosic or lignocellulosic particles such as wooden toothpicks or bamboo grilling sticks cut in desirable lengths or alternatively as cellulosic or lignocellulosic material formed into a desired shape, wherein the shape-forming process comprises steps selected from cutting, grinding, extruding, pelleting, and sawing in short lengths.

In an embodiment, the hierarchical inorganic materials are suitable for use as catalyst supports in harsh and extreme catalyst environments.

In an embodiment, the harsh and extreme environments are selected from highly caustic, highly acidic, hydrothermal, or the like.

In an embodiment, the catalyst supports are used in processes selected from purification of terephthalic acid, oxychlorinations, hydrogenolysis of sugars or sugar alcohols to polyols, amine condensation or purification reactions, and the like.

In another embodiment, the conversion is conducted at a temperature in the range from about 1000° C. to about 1500° C.

In another embodiment, the material precursor comprises a metal oxide wherein the metal is selected from the group consisting of Si, Ti, Zr, Nb, Hf, V, Mo, W, or combinations thereof.

In another embodiment, the material precursor is selected from the group consisting of SiO₂, TiO₂, ZrO₂, Nb₂O₅, HfO₂, V₂O₅, MoO₃, WO₃.

In another embodiment, the gaseous atmosphere comprises He, Ar, N₂, H₂, CO, CO₂, H₂O, NH₃, air, and combinations thereof.

In another embodiment, the infusing material is selected from the group consisting of silicon alkoxides, Tyzor LA®, Tyzor ZEC®, Bacote 20®.

In another embodiment, infusion is performed with or without removal of ash or lignin components.

### BRIEF DESCRIPTION OF THE DRAWINGS

A more complete appreciation of the invention will be readily obtained by reference to the following description of the accompanying drawings in which like numerals in different figures represent the same structures or elements.

FIG. 1 shows XRD traces for titanium oxycarbide products derived from carbothermal reduction at various temperatures in argon of a 4.44 weight ratio of filter paper to Tyzor-LA® following, according to embodiments of the invention.

FIG. 2 shows the change in oxygen content and lattice parameter of the TiCₓO_{y} samples as a function of reaction temperature in argon.

FIG. 3 is a graph illustrating change to the BET surface area of TiCₓO_{y} as a function of reaction temperature.

FIG. 4a presents XRD traces of an SiC material prepared from a pine/silica composite by heating at 1400° C. in argon (lower) followed by heating in air at 700° C. (upper), showing changes to the composite structure, according to an embodiment of the invention.

FIG. 4b XRD traces of an SiC material prepared from a poplar/silica composite by heating at 1400° C. in argon (lower) followed by heating in air at 700° C. (upper), showing changes to the composite structure, according to an embodiment of the invention.

### DETAILED DESCRIPTION OF THE INVENTION

While the present invention is described herein with reference to the preferred embodiments thereof, it should be understood that the invention is not limited thereto, and various alternatives in form and detail may be made therein without departing from the spirit and scope of the invention.

The present invention relates generally to structured metal carbide materials and a method for making and uses for same. The invention finds application in such areas as catalysts, structured catalyst supports and adsorbent materials. The invention provides a new process for generating highly durable structured inorganic materials whose properties and performance is highly tailorable via selection of the specific ceramic and/or metal precursor or precursors introduced into a hierarchical template comprising a cellulosic or lignocellulosic material in conjunction with specific heat treating conditions (temperature, ramping rates, hold times and atmospheres during the heat treating phase). The final products formed may be entirely metal carbide, entirely metal oxycarbide, entirely metal oxide, or may further contain mixtures of these products in combination with free carbonaceous structures.

### Structured Materials

Titanium carbide (TiC) is one example of a high-temperature structural material having useful properties including extreme hardness (28-35 GPa), low density (4.93 g/cm³), high thermal conductivity (m.p. 3065° C.), high electrical conductivity, and high mechanical stiffness. TiC has a crystal structure with cubic symmetry (Fm3m) and exhibits non-stoichiometry over a wide range of C:Ti ratios, having a general formula TiₘCₙ where the n/m ratio is in the range from about 0.5 to 1.0, without any change in crystal structure. Uniform fine particle TiC powders with a homogenous chemical composition are generally required for advanced materials applications, but are not limited thereto. For example, Ni, Co, and Fe can be incorporated into the base material as a second phase to improve fracture toughness. Due to the combination of metal-like and catalytic properties (e.g., activity and selectivity) or other physical properties, carbides can be used for anti-wear coatings on cutting tools, catalyst supports, and as a replacement for certain metals in catalysts.

The process of carbothermal reduction is illustrated, e.g., for conversion of titanium dioxide illustrated in equation [1]:

TiO₂(s)+3C(s)→TiC(s)+2CO(g) [1]

### Hierarchical Templates

Cellulosic and lignocellulosic materials have cellular structures which can be used as hierarchical templates. The term “hierarchical template” as used herein refers to materials having a matrix or structure characterized by ordered groupings, patterns, or cell structures suitable for generating or manufacturing patterned materials of a controlled porosity, shape, hardness, and/or surface areas. Hierarchical template materials (template materials) include, but are not limited to, cellulosic or lignocellulosic materials selected from materials including, but not limited to, e.g., hardwoods (oak, poplar, walnut, and the like), softwoods (e.g., pine, fir, balsa, and the like), bamboo, grape vines, nut shells, fruit pits, seeds, papers, or the like, and combinations. Materials can be shaped and/or sized to give the desired template shapes, e.g., by cutting short lengths of round, square, or other cross sectional shapes of the wood or bamboo. Illustrative examples of particles include, e.g., toothpicks, grilling sticks, or wood pellets. Alternatively, the template materials may be thin sheets of cellulosic or lignocellulosic papers with shapes and sizes convenient to the specific end use application, e.g., a honeycomb shape. In particular, template materials include carbonaceous structures providing a controllable source of carbon for reaction processes described herein, but are not limited thereto. Template materials may be available commercially or manufactured as needed by known or convenient methods. No limitations are intended.

Template materials (e.g., particles, shapes, sheets, and/or papers) may be leached with dilute base or acid to remove some or all of the lignin, and/or hemicellulose, as detailed in Shin et al. (Adv. Mater. 2005, 17, No. 1, 73), incorporated herein in its entirety. Leaching of the lignin, and/or hemicellulose opens the matrix or structure of the template to controlled infusion with the ceramic and/or metal precursors. In addition, removal of the lignin provides ultimately for controlled porosity of the final inorganic product. Concentration of the acid or base is selected in the range from about 0.15M to about 0.5M. Rapid removal of lignin and/or hemicellulose is achieved using various solvents and organic constituents therein including, but not limited to, e.g., water, alkanols, (e.g., methanol, ethanol, n-propanol), and combinations thereof. Various ratios may be employed. In particular, an aqueous medium comprising alcohol in a 1:1 (water:alcohol) ratio provides for rapid leaching, but is not limited thereto. Leaching when employed is conducted for periods of from about 1 hour to about 10 hours at temperatures from ambient to about 60° C. Solvents are further used to solubilize the ceramic and/or metal precursors prior to infusion. Coordination agents or chelation agents such as carbonate or bicarbonate, ammonia, organic amines, or organic acids may also be used to aid in solubilizing the ceramic or metal precursors prior to infusion.

### Precursor Materials

Any metal, metal oxide, or ceramic precursor soluble in the selected solvent can be used in conjunction with the invention without limitation. Metal precursors include, but are not limited to, e.g., SiO₂ TiO₂, ZrO₂, HfO₂ Nb₂O₅, V₂O₅, MoO₃ and WO₃ soluble in a solvent. Ceramic precursors include, but are not limited to, e.g., Si precursors soluble in a solvent. Precursors include, but are not limited to, silicon alkoxides, silanes, Tyzor LA® (DuPont, Wilmington, Del.), Tyzor ZEC® (DuPont, Wilmington, Del.), Bacote 20® (Magnesium Elektron Inc., Flemington, N.J.), and the like. Tyzor LA® is an aqueous titanium hydroxyl lactate complex. Bacote 20® is a clear, aqueous alkaline solution of stabilized ammonium zirconium carbonate that is stable at ambient temperatures

Template materials are infused with the solubilzed and/or liquidized precursors prepared in a solvent with or without prior removal of ash, lignin, or other components from the template materials via chemical or aqueous leaching. As ceramic and/or metal precursors are difficult to remove once infused into the open matrix or structure of the template, ratio of the ceramic and/or metal precursor to the free carbonaceous structures of the template is typically selected at a ratio of less than about 1 to 1, but is not limited thereto.

### Controlled Conversion of Precursor Materials

Precursor present in the matrix of the infused template is heated in an inert atmosphere until all volatile components from the infusing liquid or solvent are removed. After drying, the infused templates are heated under flowing argon or helium atmosphere for several hours at temperatures in the range from about 1000° C. to about 1500° C. to remove volatiles and convert all or part of the Si, Ti, Zr, Hf, Nb, V, Mo, or W to respective carbide or oxycarbide chemical forms. The products formed have both physical and chemical durability providing stability suitable for use in such varied applications as structured catalyst supports in severe conditions and environments. Recovery of the final inorganic product can be achieved, e.g., by removing any remaining free carbonaceous structural material from the template by pyrolizing the remaining carbon. The final inorganic product has a controlled hardness in the range from about 9.0 Mohs to about 9.5 Mohs, and/or a controlled porosity in the range from about 0.1 cc/g to about 0.8 cc/g, and/or a surface area in the range from about 40 m²/g to about 255 m²/g.

The following examples are intended to promote a further understanding of the present invention. Example 1 details use of a hierarchical template comprising a cellulosic (hardwood) material as a carbon source and Tyzor LA® as a TiO₂ source for the synthesis of TiC nanoparticles by carbothermal reduction in argon. Example 2 details the use of hierarchical template comprising a cellulosic (paper) material as a carbon source and Tyzor LA® as a TiO₂ source for the synthesis of TiC nanoparticles by carbothermal reduction in argon. Example 3 describes the synthesis of SiC via the carbothermal reduction of mineralized wood with silica in acidic conditions.

### EXAMPLE 1

In one experiment, 14.5 grams of hardwood toothpicks (Albertson's, Richland, Wash.) were cut into random length sections of about ⅛ inch to about ¼ inch. Sections were subsequently infused with 6.6 grams of an aqueous titanium hydroxyl lactate complex [(NH₄)₂Ti(OH)₂(C₃H₅O₂)₂, 2.23M in Ti)], also known as Tyzor LA® available commercially (DuPont, Wilmington, Del.), and dried at 75° C. in vacuum for about 20 hours, the weight following infusion and drying being equivalent to about 1.8 grams of TiO₂. Infused pellets (˜2.003 g) were subsequently heat treated at 1200° C. for about 2 hours in flowing argon. Hardness was measured by crushing a selection of particles between two flat plates by means of an Instron Test Apparatus. The product (0.565 grams) was found to have a crushing strength as hard or harder than a reference compound (0.8 mm Norit ROX® active carbon pellets, NoritAmericas, Inc., Marshall, Tex.). In addition, the product retained the morphology of the starting wood particles and was also found to be macroporous via visual inspection with a 3× handheld magnifier. Pore volume as determined by water adsorption, was 0.32 cc/gram. Calculations showed the initial Tyzor LA® infused particles contained the equivalent of about 11% TiO₂ with the final product containing the equivalent of about 38% TiO₂ as a mixture of free TiO₂, titanium oxycarbide, and titanium carbide (TiC). This product material was subsequently used as a catalyst support for a multimetallic catalyst composition and tested for the hydrogenolysis of a 30% sugar alcohol solution at 1200 psig H₂ and 190° C. with a 1 hour reaction time in a 300 cc stirred batch autoclave reactor. The selectivity to useful products was determined to be 93% via High Pressure Liquid Chromatography (HPLC) analysis.

### EXAMPLE 2

Example 2 details the use of cellulose hierarchical structures (template) as a carbon source and Tyzor LA® as a TiO₂ source for the synthesis of TiC nanoparticles by carbothermal reduction in argon.

A solution of [(NH₄)₂Ti(OH)₂(C₃H₅O₂)₂, 2.23 M in Ti)] also known as Tyzor LA® (DuPont, Wilmington, Del.) was used without further purification. Cellulose acetate filter paper (VWR Scientific, West Chester, Pa.) was used as a carbon precursor. Tyzor LA® solution was added to a segment (˜10 mm×10 mm) of filter paper in controlled amounts until the filter paper/Tyzor LA® weight ratio was 4.5 when dried at 100° C. overnight in air. The dried, infused Tyzor LA® filter paper composite was placed in an alumina boat and positioned in a horizontal alumina tube furnace. Temperature was increased to a temperature in the range from about 1000° C. to about 1500° C. at a rate of 4° C. per minute with subsequent heating in argon for a 2 hour duration. XRD patterns were obtained using a Philips X'ert MPD X-ray diffractometer using the Cu Kα radiation (1.54059 Å) with the X-ray generator operating at 40 kV and 50 mA. Surface oxygen content of titanium oxycarbide powders was determined using a Quantum 2000 X-ray photoelectron spectrometer. Scanning electron microscopy (SEM) and transmission electron microscopy (TEM) were done using a JEOL-JSEM 633 F and JEOL 1200, respectively, to characterize the template microstructure. Several samples with different weight ratios of filter paper to Tyzor-LA® were prepared, in the range from about 3.0-5.0, to determine the optimum ratio for the formation of stoichiometric TiC with no excess of carbon.

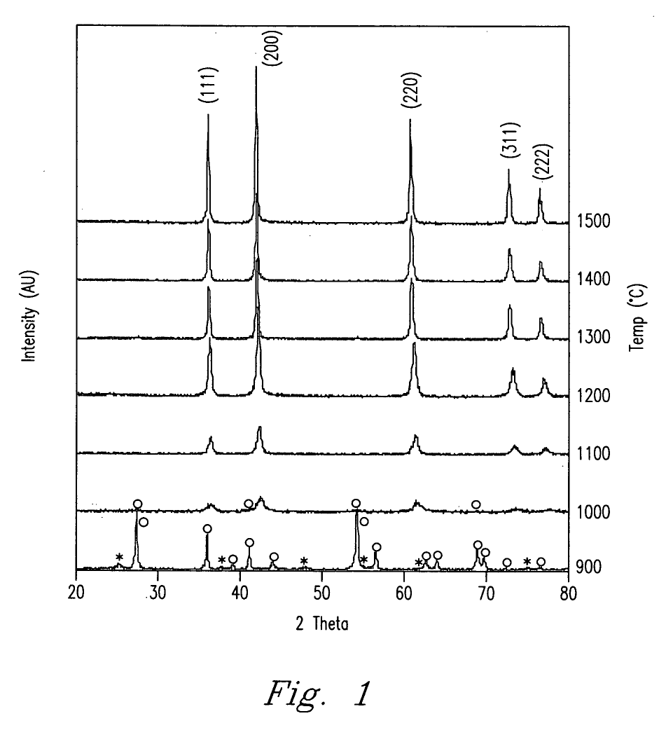

FIG. 1 presents XRD traces for titantium oxycarbide products derived from carbothermal reduction in argon of a 4.44 weight ratio of filter paper to Tyzor-LA® at temperatures ranging from 900° C. to 1500° C. At 900° C., the rutile form of TiO₂ is dominant with only a trace amount of anatase seen following heating. At 1000° C., five new diffraction peaks emerge at 2θ values of 36.29°, 42.13°, 61.13°, 73.25°, and 77.05°, respectively; features ascribed to rutile were absent. The peaks originate from titanium oxycarbide (TiCₓO_{y}). The formation of the TiC phase begins between about 900° C. and 1000° C. XRD patterns of composites heated between about 1100° C. and 1500° C. are similar to those seen at 1000° C. Subsequent heating at higher temperatures sharpens the diffraction patterns and removes spurious features confirming the presence of crystalline face-centered cubic TiC with no other phases. Features attributed to suboxides such as Ti₄O₇, Ti₃O₅, and Ti₂O₃, which serve as intermediates in the formation of TiCₓO_{y}, were not detected, indicating that the transformation of TiO₂ into TiCₓO_{y} is quite rapid during the reduction process.

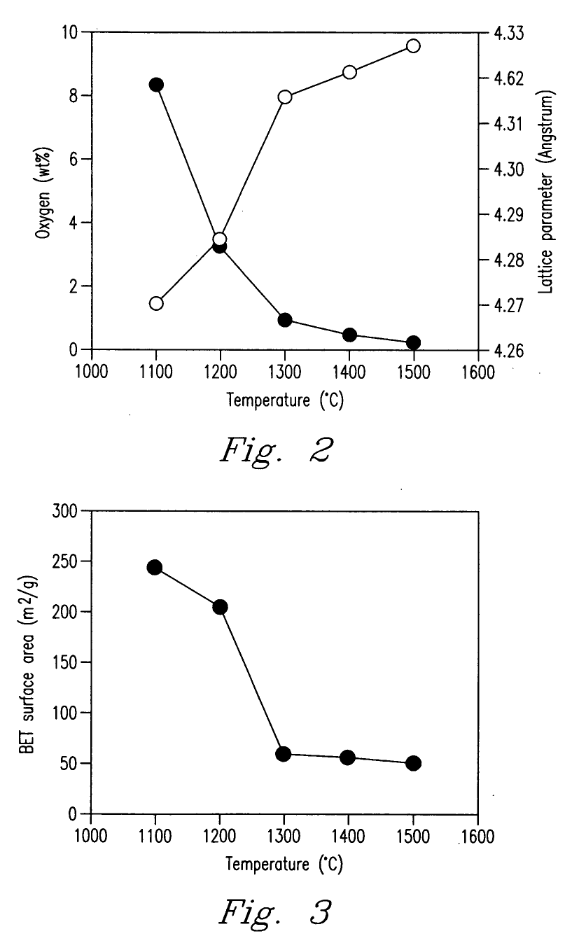

FIG. 2 shows the change in oxygen content (filled circles) and lattice parameter of the TiCₓO_{y} samples as a function of reaction temperature in argon. The lattice parameter of the TiCₓO_{y} increases with reaction temperature while oxygen content decreases, indicating that the TiO component in TiC is lowered at the higher temperatures, as described, e.g., by Koc et al. (J. Mater. Sci. 1997, 32, 3101). The lattice parameter of TiC synthesized at 1500° C. is 4.327 Å, which is consistent with that of pure TiC reported, e.g., by Storms (The Refractory Carbides, Refractory Materials Ser., Vol. 2, Academic Press, New York, 1967). In fact, the lattice parameter of the composite heated at 1300° C. is also very close to that of TiC. The oxygen content in the TiCₓO_{y} samples was estimated by X-ray photoelectron spectroscopy (XPS) measurements of the fine powders. Based on measured spectra, the sample obtained following heating at 1200° C. contained 3.27 wt % oxygen. In contrast, the oxygen content for samples heated at 1300° C., 1400° C., and 1500° C. was 0.93, 0.46, and 0.24 wt %, respectively.

A ratio of 4.44 (filter paper to Tyzor-LA®) was found to be optimum. Samples with lower ratio (<4.44) showed an extra rutile phase (TiO₂) following reaction at 1500° C. in argon. A ratio of 5.0 was found to produce an excess of about 5 wt % carbon. SEM micrographs of the TiO₂-infused paper calcined at 1000° C. in air showed the hierarchical cellulose structures resident in the filter paper were completely maintained during formation of the rutile phase of TiO₂ even after treatment at high temperature. The TiC formed at 1500° C. was a highly crystalline cubic form of TiC nanoparticles that replicated the initial cellulose structures. Transmission electron microscopy (TEM) images of the TiC product obtained at 1500° C. showed fine TiC nanoparticles with particle sizes on the order of 10 nm-50 nm and a surface area of 50 m²g⁻¹, based on the Brunauer-Emmett-Teller (BET) scale. The nano-sized TiC powders showed minimal oxygen impurity (˜0.24 wt %). A diffraction peak at 2θ=21.5° ascribed to a semicrystalline component of the filter paper disappeared following processing suggesting strong binding (cross-linking) between the cellulose fibers that comprise the filter paper and the titania precursor formed through hydrolysis. The hydrolyzed titania precursor binds to cellulose fibers following a condensation reaction between hydroxyl groups on the two species. The anatase form of titania was evident in X-ray diffraction (XRD) traces, which persisted until the material was heated above 800° C. under inert atmosphere.

FIG. 3 is a graph illustrating how the BET surface area of TiCₓO_{y} changes as a function of reaction temperature used during processing. Products synthesized at temperatures lower than 1200° C. maintain high surface area (>200 m²g⁻¹). Lower surface areas are observed at higher temperatures due to increases in crystallinity and collapse of microporous structures even under conditions where the hierarchical structures are largely maintained.

In sum, results show highly nanocrystalline TiC was prepared from a reaction between TiO₂ and cellulose that invokes carbothermal reduction in argon. The aqueous-based precursor (e.g., Tyzor-LA®) used reacted with cellulose upon heating above 1300° C. to form a cubic phase of TiC having a relatively low oxygen content. The hierarchical biological structures indigenous to the cellulose precursor were completely replicated following carbothermal reduction.

### EXAMPLE 3

Example 3 describes the synthesis of SiC via the carbothermal reduction of mineralized wood with silica in acidic conditions. The biomorphic cellular SiC ceramics were prepared by controlling the amount of silica and the size of the SiC nanoparticles. Up to 20 wt % of SiO₂ was mineralized into wood cellular structures and the hierarchical structures such as cells, lumen, and pits were retained after thermal treatment.

Wood (pine and poplar) was purchased commercially. The wood was mineralized with silica via a modified sol-gel process as detailed, e.g., by Shin et al. (Adv. Mater. 2003, 9, 76). To the solution of TEOS/HCL/EtOH/H₂O (molar ratio=1.00:1.58:4.50:46.24) pieces of dry wood were soaked and kept at 60° C. for 48 hours. Wood pieces were separated from the solution and air-dried. Dried wood/silica composite was placed in an alumina boat and then positioned in a horizontal alumina tube furnace. Temperature was increased up to about 1400° C. at 4° C. per minute rate and followed by 2 hour duration in argon. Samples were subsequently cooled to room temperature in argon. X-ray diffraction patterns were obtained as described in Example 2.

Thermogravimetric analyses (TGA) of the wood/silica composites in air and in argon, samples showed an initial weight loss of about 10 wt % at temperatures in the range from about 10° C. to about 120° C. attributed to evaporation of physisorbed water. In the 200° C. to 320° C. range, samples lost 20% to 30% of their weight due to decomposition and/or combustion of volatiles. Weight loss was more rapid in air than in the argon atmosphere. Isothermal holding at 320° C. to 500° C. led to a further loss of less volatile components from wood celluloses which required slightly elevated temperature for degradation. Silica (22.34 wt % in pine/silica and 12.56 wt % in poplar/silica composites, respectively) were detected via air-Thermogravimetric (TGA) analysis.

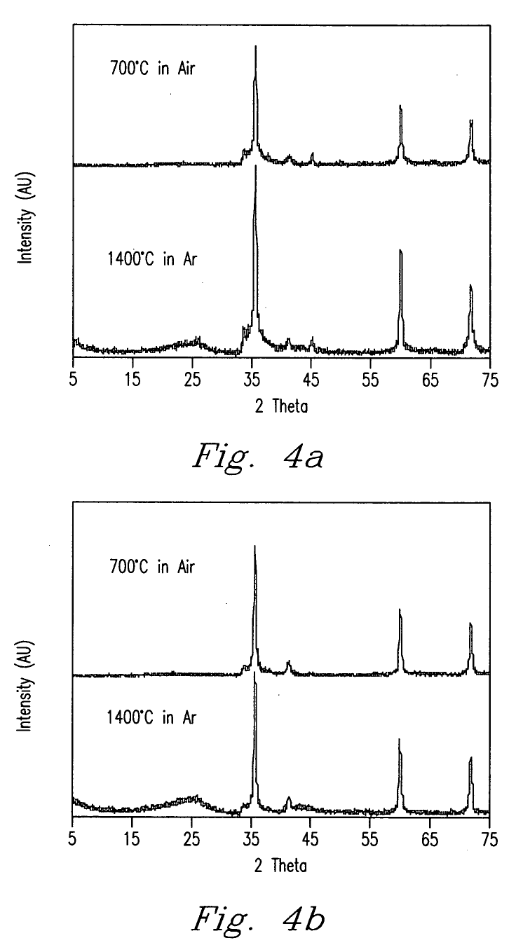

FIGS. 4a-4b present XRD patterns of as-synthesized SiC prepared from carbothermal reduction of pine/silica and poplar/silica composites, respectively. Intensity is plotted as a function of the beam orientation angle, i.e., degrees 2 Theta (2e). The lower traces correspond to formation of SiC following heating at 1400° C. for 2 hours in argon. Upper traces in each figure represent changes to the SiC structure after subsequent heating at 700° C. for 2 hours in air. Patterns reveal mainly cubic type (β-SiC) phase particles (i.e., 2θ=35.562, d₁₁₁=2.5222 Å). The d-spacing values of the four prominent peaks in the figure (left-most to right-most) are 2.5222, 2.189, 1.542, and 1.314 Å, respectively. An additional diffraction peak (corresponding to formation of a trace amount of hexagonal SiC) was detected at 2θ=33.562 (d=2.668 Å), characteristic of stacking faults on [111] planes in cubic SiC whiskers, as described by Lu et al. (Appl. Phys. Lett. 1999, 75, 507). At 1200° C., a peak (not shown) of crystalline silica (cristobalite) was observed at 2θ=21.898. Nearly quantitative conversion of SiO₂ to SiC was observed after treatment at 1400° C. in argon for 2 hours. Crystallization of silica increased with pyrolysis temperature up to 1350° C. At 1400° C. no peaks indicative of crystalline silica were observed, indicating the whole amount of mineralized silica was quantitatively reacted during the thermal treatment. As confirmed by XRD analysis, pure SiC was obtained with subsequent treatment at 700° C. in air for 2 hours.

Whole cellular structures such as cells, pits, and lumens were largely retained after thermal treatment. SEM analysis revealed presence of whiskers (˜10%) deposited randomly on the sample surface, as well as nano-sized crystalline SiC powders (˜90%). More whiskers were observed in the pine composite structures; poplar cellular networks were easy to collapse due to their being more porous and comprised of a smaller amount of mineralized silica. Energy Dispersive Spectroscopy (EDS) results showed that the atomic ratio of Si/C was 1.00:1.04 for both samples. Whisker dimensions as determined from TEM images were in the range from about 100 nm to 200 nm diameter and about 5-20 um in length. Size of SiC nanoparticles ranged from about 200 nm to about 700 nm. Whiskers were found to be highly ordered cubic type SiC. Specific surface area of final cellular SiC ceramics was in the range from about 60 m²g⁻¹ to about 100 m²g⁻¹, with pore sizes distributed randomly from nanometer to micrometers. Wood cellular structures of SiC materials were stable up to about 1400° C.

In sum, mineralized wood (pine and poplar) with silica under acidic conditions followed by carbothermal reduction to form SiC in argon atmospheres showed cellular structures were mainly maintained and wood cell walls were made of crystalline SiC nanoparticles (about 200 nm to about 700 nm). Some whiskers formed on the cellular structures that were highly ordered cubic SiC with diameters in the range from about 150 nm to about 200 nm with a length in the range from about 5 μm to about 20 μm. Semicrystalline wood cellular networks are valuable carbon precursors for metal carbide formation. Such structures are potentially useful for gas adsorption/separation at high temperatures.

### EXAMPLE 4

Example 4 describes the synthesis of ZrC via the carbothermal reduction of bamboo templates mineralized with zirconia. The ZrC product was prepared by controlling the amount of Zr and the size of template materials.

Bamboo grilling sticks (Albertson's, Richland Wash.) of about 3/32 inch diameter were cut to random lengths of from about ⅛ inches to about ⅜ inches. ˜100 g of these bamboo pellets were leached for 2 hours in 614 grams of 2% NaOH and then washed with deionized water until free of NaOH, i.e., until conductivity measurements of the wash water were the same as for deionized water. After washing, pellets were dried at 100° C. in vacuum for 16 hours. The final weight of the leached, washed, and dried pellets was 68.1 grams, constituting a 31.9% weight loss after the leaching process. Close visual inspection (via 3× handheld magnifier) showed the pellets retained their original macroporous shape and size. The leached pellets (˜25 g) were infused with Bacote 20® (Magnesium Elektron Inc., Flemington, N.J.). After vacuum drying for 16 hours at 100° C., the pellets gained 3.25 grams in weight, presumed to be a form of ZrO₂. The infused pellets were then thermally treated at a temperature in the range from about 1200° C. to about 1600° C. under argon for 2 hours.

Calculations showed the initial Bacote 20® infused particles contained the equivalent of about 11.5% ZrO₂ solids, with the final product containing a mixture of free ZrO₂, zirconium oxycarbide, and/or zirconium carbide (ZrC). In particular, at 1200° C., ZrO₂ was dominant and ZrC started to grow. At 1400° C. ZrC was dominant and a trace amount of ZrO₂ (<2%) was observed. Over 1500° C. only ZrC is observed at 2θ=33.0, 38.3, 55.3, 66.0, and 69.4°. The ZrC-containing product was found to have a crushing strength of from about 20 Newtons to about 40 Newtons per pellet via crush tests performed with an Instron Test apparatus. The product also had a surface area of about 40 m² μg (BET method) and a pore volume (porosity) of about 0.1 cc/g, as determined by water adsorption. In a reaction test performed as described in Example 1, the ZrC containing material was converted to a multimetallic catalyst of very similar composition as the catalyst in Example 1. At end of the 1 hour reaction test period, the useful product selectivity was found to be 80% via HPLC analysis.

While the preferred embodiments of the present invention have been shown and described, it will be apparent to those skilled in the art that many changes and modifications may be made without departing from the invention in its true scope and broader aspects. The appended claims are therefore intended to cover all such changes and modifications as fall within the spirit and scope of the invention.

We claim:

1. A process for preparing structured inorganic materials, comprising the steps:
providing a hierarchical template as a carbonaceous precursor comprising a cellulosic, lignocellulosic, or porous carbon material;
introducing a ceramic and/or metal precursor in a solvent into the matrix of the hierarchical template substantially infusing the template, the ceramic and/or metal precursor cross-linking within the matrix of the template;
heating the infused template in an gaseous atmosphere at a temperature and duration whereby the ceramic and/or metal precursor is converted to an inorganic product comprising a stable oxide, carbide, oxycarbide, nitride, or mixtures thereof with free carbonaceous structures;
optionally removing the free carbonaceous structures; and
wherein a final product is produced having a controlled hardness, porosity, shape, and/or surface area.

2. The process of claim 1, wherein providing comprises pre-treating, washing, or leaching the cellulosic, lignocellulosic, or porous carbon material with aqueous base, aqueous acid, a solvent, or a combination thereof at ambient temperatures up to 60° C. for periods of up to 12 hours followed by removal of the pre-treating, washing, or leaching solution and drying.

3. The process of claim 1, wherein the ceramic or metal precursor comprises a member selected from the group consisting of Si, Ti, Zr, Hf, Nb, V, Mo, W, or combinations thereof.

4. The process of claim 1, wherein the metal precursor is selected from the group consisting of SiO₂, TiO₂, ZrO₂, Nb₂O₅, HfO₂, V₂O₅, MoO₃, WO₃, or combinations thereof soluble in a solvent.

5. The process of claim 4, wherein the metal precursor is selected from the group consisting of silicon alkoxides, silanes, Tyzor LA®, Tyzor ZEC®, Bacote 20®, or combinations thereof.

6. The process of claim 1, wherein the ratio of ceramic and/or metal precursor to free carbonaceous structures in the matrix of the template is less than 1 to 1.

7. The process of claim 1, wherein the solvent comprises an acid or base.

8. The process of claim 7, wherein the acid has a concentration in the range from about 0.15 M to about 0.5 M.

9. The process of claim 7, wherein the solvent further comprises water and an alcohol.

10. The process of claim 9, wherein the ratio of water to alcohol is about 1:1.

11. The process of claim 1, wherein the gaseous atmosphere comprises a member selected from the group consisting of He, Ar, N₂, H₂, CO, CO₂, NH₃, air, and combinations thereof.

12. The process of claim 1, wherein the removing of free carbonaceous structures comprises pyrolizing the structures.

13. The process claim 1, wherein the heating is selected in the range from about 700° C. to about 1500° C.

14. The process claim 1, wherein the hardness is in the range from about 9.0 Mohs to about 9.5 Mohs.

15. The process claim 1, wherein the porosity is in the range from about 0.1 cc/g to about 0.8 cc/g.

16. The process claim 1, wherein the surface area is in the range from about 40 m²/g to about 255 m²/g.

17. The process of claim 1, wherein the final product is used as a catalyst support in extreme reaction or process environments.

18. The process of claim 17, wherein the extreme catalyst reaction or process environments are selected from the group consisting of highly caustic, highly acidic, hydrothermal, or combinations thereof.

19. The process of claim 17, wherein the catalyst supports are employed in processes selected from the group consisting of amine condensation, purification reactions, purification of terephthalic acid, oxychlorinations, hydrogenolysis of sugars and/or sugar alcohols to polyols, or combinations thereof.
